(19) United States
(12) Patent Application Publication
(10) Pub. No.: US 2014/0360966 A1
(43) Pub. Date: Dec. 11, 2014

(54) DUAL COMPARTMENT CONTAINER FOR HOLDING SOLID AND LIQUID

(71) Applicant: Bryan Howard, Holland, MI (US)

(72) Inventor: Bryan Howard, Holland, MI (US)

(21) Appl. No.: 14/286,138

(22) Filed: May 23, 2014

Related U.S. Application Data
(60) Provisional application No. 61/831,876, filed on Jun. 6, 2013.

(51) Int. Cl. B65D 1/04; A61J 1/03

(52) U.S. Cl. CPC B65D 1/04; A61J 1/035
USPC 215/6

(57) ABSTRACT

A packaging system includes a bottle defining two separate closed compartments for separately carrying a consumable liquid and a solid. Liquid is held in the first compartment by a cap, and a solid (such as medication, pill, or other solid) is held in the second compartment by a closure member such as a sheet or film. The system facilitates injections of the solid by providing sufficient liquid to permit swallowing the solid. A related method includes storing two related products, one solid and one liquid, in a single container so that a user can use one of the products to facilitate injections of the other.

This application claims benefit under 35 USC section 119(e) of a provisional application Ser. No. 61/831,876, filed Jun. 6, 2013, entitled DUAL COMPARTMENT CONTAINER FOR MEDICATION AND LIQUID, the entire contents of which are incorporated herein by reference.

### FIELD OF THE INVENTION

The present invention relates to containers holding both a solid and a liquid, with the solid held in a first compartment (such as over-the-counter or prescription medication, supplements, vitamins, or oral care products), and the liquid held separately in a second compartment (such as water or flavored drink or mouthwash). More specifically, this invention relates to dual compartment containers in which one compartment contains the fluid and the other compartment contains a pre-measured dose of over the counter or prescription medication, supplement, vitamin, or oral care product.

### BACKGROUND OF THE INVENTION

A wide variety of over-the-counter or prescription medications, supplements, and vitamins are available in today's market, often in capsule or tablet form. Because of the composition of those medications, it is desirable that the medications be stored for later use, and protected from damage, deterioration and contamination. Accordingly, it is well known to supply measured doses of capsules or tablets (often collectively referred to as “pills”) in individual dosage packets. Typical over-the-counter medicines stored in this fashion include pain killers such as aspirin or ibuprofen. Small individual packages of pre-measured doses are convenient to carry in pocket or purse, and can remain in a sealed packet until needed. It is estimated that American consumers consume thousands of such pre-packaged doses of medications daily. Similarly, certain prescription medications may be so packaged and dispensed.

One of the inconveniences associated with the consumption of such pre-packaged tablets and pills, however, is the necessity for consumption of a small quantity of liquid to assist in swallowing the pills. Many pills manufactured have an inherently unpleasant taste. Other pills are purposefully infused with bitter-tasting flavorings to discourage accidental ingestion of such medications by small children. Still other pills are composed in such a fashion as to dissolve quickly in the mouth, when it would be more beneficial for the medication to be ingested into the stomach of the user before the medication begins to dissolve.

For all of the foregoing reasons, it is typical that pills be consumed with a small quantity of liquid to assist the user in swallowing the dose, and speeding the transit of the tablet or pill from the mouth to the stomach.

However, it is often the case that the tablet or pill is needed by the user in situations and locations where no liquid is available to assist in swallowing the pills.

It is desirable to provide a vessel that can hold both a pre-measured dosage of over the counter or prescription medication, supplement, vitamin, or oral care product, and a quantity of liquid to assist in the ingestion of the pre-measured solid dosage (or to assist in use of the solid product).

### SUMMARY OF THE INVENTION

In one aspect of the present invention, a single vessel is provided for storage and dispensing of a liquid and a solid, such as over-the-counter or prescription medications, supplements, vitamins, or oral care products. The vessel includes a first compartment containing fluid, a second compartment containing a premeasured dose of over the counter or prescription medication, supplement, vitamin, or oral care product, a barrier separating said first compartment from said second compartment, and a first closure forming a seal for said first compartment. The vessel also includes a second closure forming a seal for said second compartment, with said barrier being between said first compartment and said second compartment and being impervious to said fluid.

In another aspect of the present invention, a packaging system is provided for separately carrying a consumable liquid and a solid, where the liquid facilitates ingestion of the solid. The system includes a bottle defining a first compartment with a first access opening, an outwardly-facing second compartment with a second access opening, and a barrier wall separating the first and second compartments. Liquid is located in the first compartment, and a cap closes the first access opening. A solid is located in the second compartment, and a closure member closes the second access opening.

In another aspect of the present invention, a method is provided for separately packaging a consumable liquid and a solid, where the liquid is associated with ingestion or use of the solid. The method includes providing a bottle defining a first compartment with a first access opening, an outwardly-facing second compartment with a second access opening, and a barrier wall separating the first and second compartments. The method further includes putting liquid in the first compartment, using a cap to close the first access opening, putting a solid in the second compartment, and using a removable closure member to close the second access opening.

In another aspect of the present invention, a packaging system comprises a water bottle filled with water and having a concave bottom defining an outwardly-facing cavity, a medication in the cavity; and a removable closure member closing the cavity and holding the medication in the cavity.

An object of the present invention is to provide a vessel comprised of two discrete compartments separated by a common barrier, wherein one compartment holds a pre-measured dosage of over the counter or prescription medication, supplement, vitamin, or oral care product and a second compartment contains a quantity of liquid.

Another object of the present invention is to provide a removable and disposable closure for each compartment to contain the contents of the vessel until use of the medication is required.

Another object of the invention is to provide a unitary device which incorporates both a predetermined dose of medication and a portion of liquid sufficient to facilitate the swallowing of the medication as needed.

These and other objects of the present invention will be best understood as explained in the following description of drawings and of the preferred embodiments.

### BRIEF DESCRIPTION OF THE DRAWINGS

FIG. 1 is a front view of the present invention, depicting the vessel, its separate compartments, and individual tablet dose separate from the vessel.

FIG. 2 is a second front view of the present invention as a completed assembly, depicting the vessel, its separate compartments, and the individual tablet dose contained within the vessel.

### DETAILED DESCRIPTION OF THE EMBODIMENTS

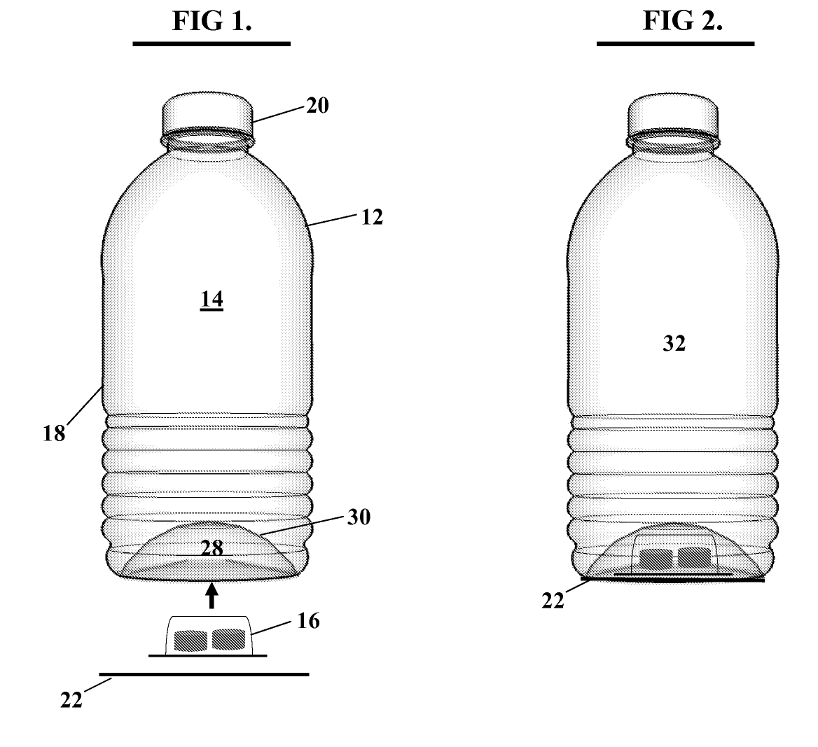

With reference now to FIGS. 1 and 2, the vessel of the present invention will be best understood. It is noted that any reference to up, down, lateral, or other orientation, is not intended to be unnecessarily restrictive, but instead is intended for relative reference purposes and/or to assist in the following description.

Invention comprises a vessel 12, typically in the form of a bottle or cylinder formed of molded plastic. Vessel 12 may be transparent, translucent or opaque, or may have variations in opacity, around its circumference or along its length, including the use of “window” elements. The inclusion of either transparency or window elements permits the user to verify that the contents of the vessel are intact. The interior of the vessel 12 defines a first compartment 14. Near a bottom end of the vessel wall 18 of vessel 12 is a barrier 30, typically in the form of a domed section of wall which is formed contiguously with the vessel wall 18 of vessel 12, or adhered to the inner circumference of the vessel wall 18 of vessel 12, thereby creating a complete barrier in the bottom of vessel 12, which, by virtue of its domed shape, creates a second compartment 28 at the bottom of vessel 12 which is separate from and sealed in relation to first compartment 14. First compartment 14 is provided with a first closure 20 in the form of a flexible paper, foil, film, plastic circular element, or threaded cap forming a fluid-tight seal for first compartment 14.

A second closure 22 in the form of a flexible paper, foil, film, or plastic circular element is applied to the base of vessel 1 2, forming a closed second compartment 28 (also called a “down-facing compartment” or an “outboard-facing compartment” herein) for holding a dose of over the counter or prescription medication, supplement, vitamin, or oral care product 16. Barrier 30 separates the first compartment 14 and the second compartment 28, thereby preventing intermixture of the contents of the two compartments.

The vessel 12 so constructed is compact, light in weight, inexpensive to manufacture and readily disposable. The illustrated vessel 12 is illustrated as a disposable water bottle with threaded cap that is about 2½″ high and 1¼″ diameter; however it is contemplated that differently sized and shaped containers can be used. The illustrated vessel 12 includes a threaded cap 20, allowing the user to drink as much liquid as needed, and then replace the threaded cap 20. The illustrated bottom second closure 22 is illustrated as an adhered foil or sheet. It is contemplated that the second closure 22 will preferably be a one-time-attached member that once removed cannot be re-attached. However, a scope of the present invention includes using an adhesive permitting re-attachment, or using a threaded member that can be re-attached similar to the cap 20. The illustrated solid 16 (also called a “consumable solid” herein) is a bubble-packaged two-pill arrangement. However, it is contemplated that the solid 16 does not need to be separately packaged, nor that it be limited to only 2 pills. For example, the liquid in compartment 14 could be any drink or even mouth wash, and the solid in compartment 28 could be any solid such as dental floss.

The invention functions as follows:

The vessel 12 including barrier 30 is manufactured, typically in an injection or blow molding process. The barrier 30 may be manufactured as part of the vessel 12 or affixed to the interior of the cylindrical wall 18 by suitable means such as adhesives or thermal welding. The first compartment 14 of vessel 12 is then filled with fluid, which could be water or any other non-perishable, pleasant tasting digestible or ingestable liquid. The fluid may also be in the form of a liquid medication complimentary to the other medications being stored in the vessel 12 as will be further described.

Once the vessel 12 is charged with the fluid 32, the first closure 20 is applied forming a fluid-tight seal between the first closure 20 and the cylindrical walls 18 of the vessel 12.

The premeasured dose of over the counter or prescription medication, supplement, vitamin, or oral care product 16 is then placed in the second compartment 28, and second closure 22 is applied to the lower cylindrical wall of the vessel 12 and sealed in place, thereby containing the dose of over the counter or prescription medication, supplement, vitamin, or oral care product 16 within the second compartment 28 of vessel 12. The completed assembly thereby includes, in a single container, a dose of over the counter or prescription medication, supplement, vitamin, or oral care product 16, which is separated from fluid 32, and both the medication and fluid remain sealed within their respective compartments in the vessel until needed.

In use, the consumer will remove second closure 22 from the bottom of vessel 12 thereby releasing the dose of over the counter or prescription medication, supplement, vitamin, or oral care product 16 which the user may transfer from hand to mouth. The first closure 20 is then removed from the vessel 12, allowing the consumer to ingest the fluid 32 to assist in swallowing the medication 16, following which the entire vessel and closures may be discarded, inasmuch as the container is not intended for reuse. It will be appreciated, however, that the vessel 12 may be provided with reusable first and second closures, allowing the consumer to “recharge” both the second compartment 28 with medication and the first compartment 14 with fluid.

In a second embodiment, second compartment 28 of vessel 12 may be filled with a liquid medication instead of a pill. In a yet further embodiment of the invention, first compartment 14 contains a first component of a binary or two-part medication, and second compartment 28 contains a second part of said binary or two-part medication.

It will be appreciated that the form of the present invention described above and shown in the accompanying drawings is illustrative only and is not intended to limit the scope of the invention to less than that described in the following claims:

The embodiments of the invention in which an exclusive property or privilege is claimed are defined as follows:

1. A single vessel for storage and dispensing of a liquid and a solid, such as over-the-counter or prescription medications, supplements, vitamins, or oral care products, comprising:
a first compartment containing fluid;
a second compartment containing a premeasured dose of over the counter or prescription medication, supplement, vitamin, or oral care product;
a barrier separating said first compartment from said second compartment;
a first closure forming a seal for said first compartment;
a second closure forming a seal for said second compartment; and
said barrier being between said first compartment and said second compartment and being impervious to said fluid.

2. A packaging system for separately carrying a consumable liquid and a consumable solid, where the liquid facilitates ingestion of the solid, comprising:
a bottle defining a first compartment with a first access opening, an outwardly-facing second compartment with a second access opening, and a barrier wall separating the first and second compartments;
liquid in the first compartment;
a cap closing the first access opening;
a consumable solid in the second compartment; and
a closure member closing the second access opening.

3. The packaging system defined in claim 2, wherein the cap includes threads.

4. The packaging system defined in claim 2, wherein the solid includes at least one pill carrying an oral medication.

5. The packaging system defined in claim 3, wherein the solid includes a separate package carrying the at least one pill.

6. The packaging system defined in claim 5, wherein the separate package includes a bubble pack containing the pill.

7. The packaging system defined in claim 2, wherein the barrier wall is a bottom wall of the bottle.

8. The packaging system defined in claim 2, wherein the bottle includes a threaded top and an upper lip capable of resealingly engaging the cap.

9. The packaging system defined in claim 2, wherein the bottle is translucent or transparent so that both the liquid and the solid can be seen when contained within the bottle.

10. A packaging system comprising:
a water bottle filled with water and having a concave bottom defining an outboard-facing cavity;
medication in the cavity; and
a removable closure member closing the cavity and holding the medication in the cavity.

11. A method of separately packaging a consumable liquid and a solid, where the liquid is associated with ingestion or use of the solid, comprising:
providing a bottle defining a first compartment with a first access opening, an outboard-facing second compartment with a second access opening, and a barrier wall separating the first and second compartments;
putting liquid in the first compartment;
using a cap to close the first access opening;
placing a solid in the second compartment; and
using a removable closure member to close the second access opening.
